(19) United States
(12) Patent Application Publication
(10) Pub. No.: US 2024/0022525 A1
(43) Pub. Date: Jan. 18, 2024

(54) SYSTEMS, DEVICES, AND METHODS RELATED TO MANAGING WIRELESS DEVICE CONNECTIONS AS A SET

(71) Applicant: SKYWORKS SOLUTIONS, INC., Irvine, CA (US)

(72) Inventors: Samuel F. HISHMEH, Nolensville, TN (US); Samuel Christian BOEGLI, Beaverton, OR (US)

(21) Appl. No.: 18/211,956

(22) Filed: Jun. 20, 2023

Related U.S. Application Data
(60) Provisional application No. 63/354,209, filed on Jun. 21, 2022.

(51) Int. Cl. H04L 49/112

(52) U.S. Cl. CPC H04L 49/112

(57) ABSTRACT

In some embodiments, a system can include an arbiter device, a first client device and a second client device configured as parts of a coupled set, and a wireless network architecture. The wireless network architecture can communicatively couple the arbiter device, the first device, and the second device. The arbiter device can be configured to receive a switch arbiter message from the first client device, determine that the coupled set includes the first client device and the second client device, and based on the determination, forward the switch arbiter message to the second client device.

### CROSS-REFERENCE TO RELATED APPLICATION(S)

This application claims priority to U.S. Provisional Application No. 63/354,209 filed Jun. 21, 2022, entitled MANAGING WIRELESS DEVICE CONNECTIONS AS A SET, the disclosure of which is hereby expressly incorporated by reference herein in its entirety.

### BACKGROUND

### Field

The present disclosure relates to managing wireless device connections as a set.

### Description of the Related Art

An electronic device such as a computer, tablet, smartphone, or the like can interface with a user through a number of interface devices. Such interfacing functionality can be controlled and/or supported by, for example, an arbiter attached to or part of the electronic device, so as to allow appropriate transfer of information between the electronic device and the interface devices.

### SUMMARY

In accordance with a number of implementations, the present disclosure relates to a system including an arbiter device, a first client device and a second client device configured as parts of a coupled set, and a wireless network architecture that can communicatively couple the arbiter device, the first device, and the second device. The arbiter device can be configured to receive a switch arbiter message from the first client device, determine that the coupled set includes the first client device and the second client device, and based on the determination, forward the switch arbiter message to the second client device.

In some embodiments, the arbiter device can be configured to receive an acknowledgement from the second client device, and in response to the acknowledgment, disconnect the second device.

In some embodiments, the first client device can be configured to receive an acknowledgment from the arbiter device, and in response to the acknowledgment, disconnect a connection to the arbiter device.

In some embodiments, the first client device can be configured to receive the switch arbiter message from a second arbiter device, and forward the switch arbiter message to the arbiter device.

In some embodiments, the first client device can be configured to make a determination that the second arbiter device is a trusted arbiter device, and based on the determination, forward the switch arbiter message to the arbiter device.

In some embodiments, the first client device can be configured to receive an acknowledgement of the switch arbiter message from the arbiter device, and based on the acknowledgment, disconnect from the arbiter device.

In some embodiments, the first client device can be configured to determine that the second arbiter device is an unauthorized device, disconnect a connection to the second arbiter device, and deny future switch arbiter messages from the second arbiter device.

In some embodiments, the first client device can be configured to reconnect with the arbiter device, and inform the arbiter device that the second arbiter device is the unauthorized device.

In some embodiments, the first client device can be configured to receive a second switch arbiter message from a third arbiter device, make a determination that the third arbiter device is an untrusted arbiter device, and based on the determination, reject the second switch arbiter message.

In some embodiments, the first client device can be configured to inform the arbiter device whether the third arbiter device is a trusted arbiter device during a connection establishment with the arbiter device.

In some embodiments, the arbiter device can maintain a first list of trusted arbiter devices and the first client device maintains a second list of trusted arbiter devices.

In some embodiments, the first list of trusted arbiter devices and the second list of trusted arbiter devices can be maintained in sync.

In some embodiments, the arbiter device can be configured to send the first list of trusted arbiter devices to the second client device based on a determination that the coupled set includes the first client device and the second client device.

In some embodiments, the first client device can be configured to remove a second arbiter device from the second list of trusted arbiter devices based on a failed authentication of the second arbiter device to the first client device.

In some embodiments, the arbiter device can be configured to send a coupled set change message to the second client device based on a determination that the coupled set includes the first client device and the second client device.

In some embodiments, the coupled set change message can reflect a removal of the second client device from the coupled set.

In some embodiments, the second client device can be configured to receive the switch arbiter message from the arbiter device, disconnect a connection to the arbiter device, and search for a connection request from a second arbiter device.

In some embodiments, the system may further include a third client device that can be configured as a part of the coupled set wherein the first client device and the third client device are associated with the same position within the coupled set.

In some embodiments, the first arbiter device can disconnect a first connection to the first client device and establishes a second connection with the third client device based on the first client device and the third client device having the same position within the coupled set.

In some embodiments, a wireless electronic device can be configured to receive a disconnection request from a first device, disconnect the first device, determine that the first device is in a set with a second device, and forward the disconnection request to the second device based on the determination.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 depicts an example network topology of wireless electronic devices, in accordance with one or more embodiments.

FIG. 2 depicts an example client device and an example arbiter device, in accordance with one or more embodiments.

FIG. 3 depicts an example arbiter switch procedure for a client device that receives an arbiter switch request, in accordance with one or more embodiments.

FIG. 4 depicts an example arbiter switch procedure for a client device that receives a forwarded arbiter switch request, in accordance with one or more embodiments.

FIG. 5 depicts an example flowchart of a method that can be used to prevent arbiter switch denial-of-service (DDoS) attacks, in accordance with one or more embodiments.

### DETAILED DESCRIPTION OF SOME EMBODIMENTS

The headings provided herein, if any, are for convenience only and do not necessarily affect the scope or meaning of the claimed invention.

Advancements in wireless connectivity has enabled many traditionally wired applications to become entirely wireless. Wireless gaming, wireless audio, and wireless charging are but a few such transformed applications that have gone from wired to wireless. Unfortunately, the transformation of wired to wireless is not without challenges. One such challenge may arise in managing connectivity between or among multiple wireless devices.

In some scenarios, wireless devices can be designed to work in a set or as a set. For example, truly wireless earbuds having a left wireless earbud and a right wireless earbud are designed to work in a set (e.g., coupled set) and may be connected to one source device. One challenge that may arise for such a set of wireless devices may arise from synchronously switching an a source device. If a switching of audio sources (e.g., from a smartphone to a laptop) is to be desired for the earbuds, the switching of the audio sources needs to happen such that both earbuds synchronously switch to the new audio source. In other words, one earbud should not remain connected to a previous audio source when the other earbud makes a new connection with the new audio source. As another example, a gamepad, a headset, and a media control fob could be wirelessly connected to a computer and a user may desire to continue gaming experience on a cloud-gaming enabled TV. It would be desirable for the user to have each of the gamepad, headset, and media control to collectively connect (transfer connections) to the cloud-gaming enabled TV rather than separately connecting each of the wireless devices. In the cloud-gaming example, the cloud-gaming enabled TV may operate as both a source and as a destination, sending and receiving signals. It is noted here that more any number of wireless devices may synchronously switch its source or destination, and that connections between the wireless devices and the source or the destination may be One-to-Many, Many-to-One, or Many-to-Many.

Another challenge of wireless transformation relates to prevention of unauthorized (untrusted) connections. For example, without intention, a neighbor's TV may attempt to connect to client devices. As another example, a malicious actor may attempt denial-of-service (DDoS) attack by continuously taking over connections. Both scenarios may result in less than satisfactory experience for a user who actively enjoys the use of the client devices. Improved approaches disclosed herein can address such challenges and help manage multiple wireless devices as a coupled set.

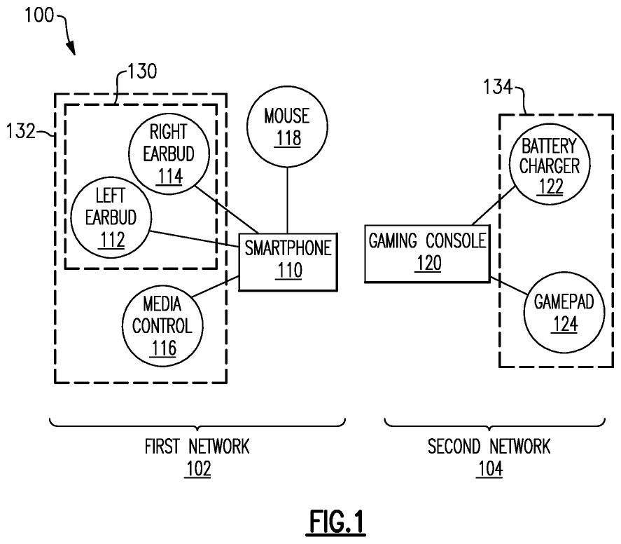

FIG. 1 depicts an example network topology 100 of wireless electronic devices, in accordance with one or more embodiments. The example network topology 100 includes two networks 102, 104. A smartphone 110 is a central hub of the first network 102 and a gaming console 120 is a central hub of the second network 104. The smartphone 110 is wirelessly connected to a left earbud 112, a right earbud 114, and a media control (e.g., a remote control) 116. The gaming console 120 is wirelessly connected to a battery charger (e.g., wired or wireless) 122 and a gamepad 124.

In the present disclosure, the host devices 110, 120 can be referred as “arbiters” or “arbiter devices” and the wireless devices 112, 114, 116, 122, 124 can be referred as “clients” or “client devices.” As described above, a user may desire to connect a client device that is connected an arbiter to a different arbiter (e.g., perform an arbiter switch). For example, a user may desire to disconnect the media control 116 from the smartphone 110 and, instead, connect it to the gaming console 120. In some instances, a user may desire to perform an arbiter switch for a set of client devices. For example, a user may desire to disconnect both the left earbud 112 and the right earbud 114 of a coupled set 130 from the smartphone 110 and connect the coupled set 130 to the gaming console 120. It is noted that a coupled set can include more than two client devices such as another coupled set 132 that includes the left earbud 112, the right earbud 114, and the media control 116. Further, as yet another coupled set 134 including a battery charger 122 and a gamepad 124 indicates, a coupled set is not limited by types of client devices. Some client devices, such as the mouse 118, may not be part of any coupled set. Accordingly, it is to be understood that a coupled set can be a group of any known devices that are designed to operate together.

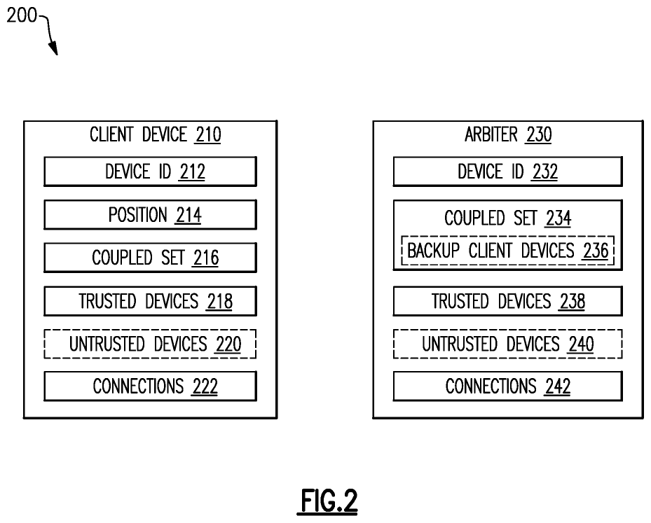

FIG. 2 depicts an example client device 210 and an example arbiter device 230, in accordance with one or more embodiments. The example client device 210 may identify itself with a device identifier (ID) 212. The device ID can be a MAC address or any other ID. The example client device 210 may have a “position” for a client device in a coupled set. For instance, a left earbud 112 may have “LEFT” as its position and a right earbud 114 may have “RIGHT” as its position for an earbud coupled set. The media control 116 may have “MEDIACTRL” as its position.

The example client device 210 can store, update, and/or otherwise manage information related to a coupled set (coupled set information) 216 to which the example client device 210 belongs or is a part of. For example, the left earbud 112 client device can maintain information that indicates that the coupled set 130 includes the left earbud 112 and the right earbud 114. Similarly, the right earbud 114 client device can maintain the same information that the right earbud 114 also belongs or is a part of the coupled set 130. The coupled set information 216 can additionally maintain position information of each member client device (e.g., “LEFT,” “RIGHT,” “UP,” “DOWN,” “FRONT,” “MIDDLE,” “LEFTMOST,” “(3, 5) position in a matrix,” etc.).

The example client device 210 can maintain a list of trusted devices 218 and, optionally, untrusted (unauthorized) devices 220. The list of untrusted devices 220 can be optional in a sense that some implementations can treat any devices that are not listed in the trusted list 218 as untrusted devices. The lists 218, 220 can help the client device 210 determine whether to accept or reject a message coming from a different device, such as an arbiter switch message from an unknown arbiter. The example client device 210 can maintain information relating to connections 222. The connections 222 information can be of currently connected devices (e.g., actively connected arbiter device) or previously connected devices.

Similar with the example client device 210, the example arbiter device 230 may identify itself with its own device ID 232, maintain information relating to coupled set 234, trusted devices 238, untrusted devices 240, and connections 242. The list of untrusted devices 240 may be optional for the reasons described above.

The example arbiter device 230 may additionally maintain backup client devices 236 information or a list thereof. It was described that the coupled set information 216 of the example client device 210 can maintain position information of client devices in a coupled set. Similarly, the example arbiter device 230 can maintain coupled set information 234 with position information. Following with the smartphone 110 example of FIG. 1, the smartphone 110 (an arbiter device) can know that the left earbud 112 having a position “LEFT” has disconnected due to low battery. The smartphone 110 can search for a backup client device with the same position “LEFT” from its backup client devices 236 information. If the backup client device exists for the same position, then the arbiter device 230 may swap in the backup client device for the position. Once swapped, the arbiter device 230 may update its coupled set information 234 and send the updated coupled set information to other devices in the coupled set information 234. Staying with the smartphone 110 example, the smartphone 110 updates its coupled set information to indicate that a backup “LEFT” earbud is no longer a backup and send the updated coupled set information to the right earbud 114. In response, the right earbud 114 may update its own coupled set information 216. The swapping in of the backup client device can occur in real-time or in substantially real-time.

In some embodiments, any or all of information 212, 214, 216, 218, 220, 222, 232, 234, 236, 238, 240, 242 can be maintained on a cloud database. Further, an arbiter device(s) and/or a client device(s) may access and add/modify/remove any or all of the information 212, 214, 216, 218, 220, 222, 232, 234, 236, 238, 240, 242 on the cloud database.

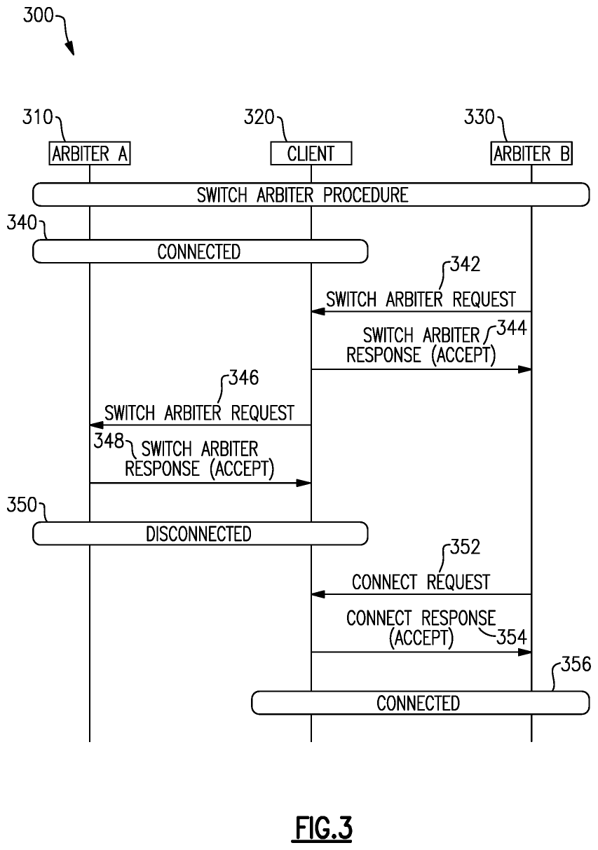

FIG. 3 depicts an example arbiter switch procedure 300 for a client device that receives an arbiter switch request, in accordance with one or more embodiments. The example arbiter switch procedure 300 shows a client device 320 that starts out connected to a first arbiter device 310 (“Arbiter A”). At block 340, the client device 320 can be connected to the first arbiter device 310 as a part of a coupled set. The first arbiter device 310 and the client device 320 may each maintain coupled set information (e.g., coupled set information 216, 234 of FIG. 2). For example, the client device 320 may be a left earbud of a pair that is connected to an arbiter device 310 that is a smartphone and the smartphone can simultaneously be connected to the right earbud of the pair. Either or both the left earbud and the smartphone can maintain information that the left earbud is part of the coupled set with the right earbud.

For a connection established or to be established, a client device can send a “coupled set” message to an arbiter device to inform the arbiter device of other devices in the coupled set with the client device. For instance, at block 340, the client device 320 can send a “coupled set” message to the first arbiter device 310. Similarly, at block 356, the client device 320 can send a “coupled set” message to a second arbiter device 330 (“Arbiter B”). As described in relation to FIG. 2, the “coupled set” message can provide information (e.g., coupled set information 216, 234 of FIG. 2) of client devices that are in the same coupled set with the client device sending the coupled set message. For example, the “coupled set” message can inform device IDs and positions of other client devices in the coupled set.

An arbiter device receiving the “coupled set” message can examine the “coupled set” message and accept or reject the “coupled set” message. If the arbiter device accepts the message, it will update its coupled set information (coupled set information 234 of FIG. 2) and respond with a “coupled set accept” message. In some embodiments, the arbiter device may reject the “coupled set” message and send its own “coupled set” message to the client device. An example instance could be where a gamepad (a client device) establishes a connection and informs a gaming console (an arbiter device) that it should be in a coupled set with a gaming headset (another client device) with a “coupled set” message. The gaming console may determine that the gaming headset is already connected with a different gamepad and reject the “coupled set” message (e.g., with a “coupled set reject” message) and inform the gamepad that the gaming headset should instead be in the coupled set the different gamepad by sending its own “coupled set” message. In these scenarios where an arbiter device rejects and sends its own “coupled set” message, client devices may accept the arbiter device's “coupled set” message and update their own coupled set information 216. In some implementations, the coupled set information 216, 234 can be changed in several situations from any arbiter device and from any client device, regardless of if all or any client devices are connected in the coupled set. It can be up to an arbiter device to resolve any coupled set changes and keep “coupled set” information 216, 234 in sync among the client devices.

If the coupled set information 216, 234 changes for any coupled set on any arbiter device or client device, then that device can send an updated “coupled set” message to other devices in the coupled set. For instance, an arbiter device may notify all devices in the coupled set of any changes, including devices that are removed from the set. If a removed device is not connected, then the arbiter device can be responsible for informing the removed device the next time it connects.

At block 342, the client device 320 can receive a “switch arbiter request” message 342 from a second arbiter device 330 outside its network. If the second arbiter device 330 is a trusted device, the client device 320 can accept the message and respond with a “switch arbiter response” message 344. Whether the second arbiter device 330 is trusted device can be determined based on a list of trusted devices and/or a list of untrusted devices (e.g., the lists 238, 240 of FIG. 2) maintained by the client device 320. If the second arbiter device 330 is not a trusted device, then the client device 320 can reject the “switch arbiter request” message 342 and the procedure can terminate.

If the second arbiter device 330 is a trusted device, then the client device 320 can send a “switch arbiter request” message 346 to its currently active arbiter, the first arbiter device 310. In some embodiments, the “switch arbiter request” message 346 may be the “switch arbiter request” message 342 that is now forwarded by the client device 320 to the first arbiter 310.

The first arbiter device 310, can acknowledge the “switch arbiter request” message 346 and respond with a “switch arbiter response” message 348. At block 350, the client device 320 can acknowledge the message 348 and disconnect from the first arbiter device 310. After the disconnection, the client device 320 can connect to the second arbiter device 330. In some implementations, the connection may involve searching and pairing between the client device 320 and the second arbiter device 330 in which the client device 320 may receive a “connect request” message 352 from the second arbiter device 330. Then, the client device 320 can send a “connect response” message 354 that accepts the connection request. At block 356, the client device 320 and the second arbiter device 330 can make a connection. It is noted that, in some implementations, the order of the blocks in the procedure 300 can be rearranged, performed simultaneously or sequentially, and certain blocks may be omitted entirely.

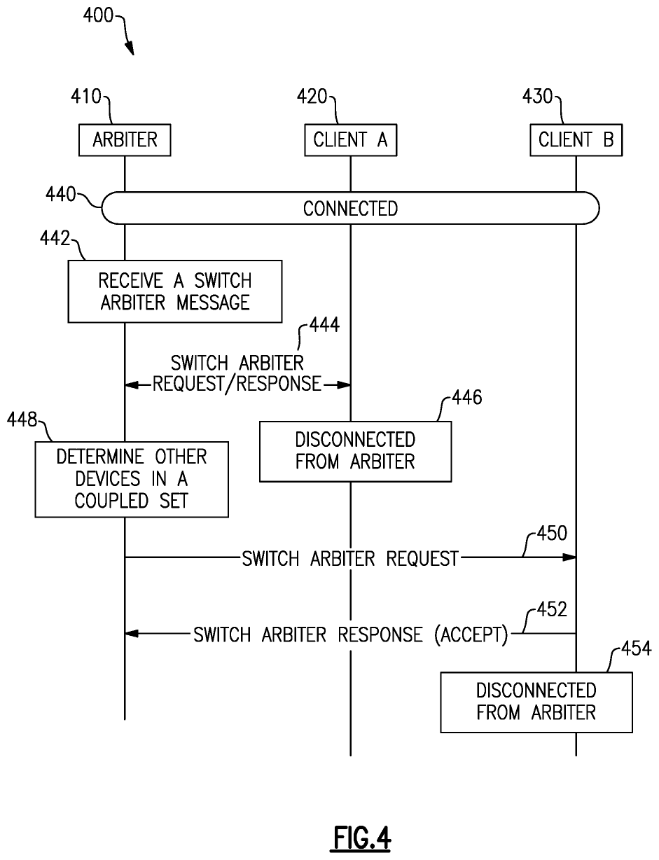

FIG. 4 depicts an example arbiter switch procedure 400 for a client device that receives a forwarded arbiter switch request, in accordance with one or more embodiments. The example arbiter switch procedure 400 illustrates interactions among an arbiter device (“Arbiter”) 410, a first client device (“Client A”) 420, and a second client device (“Client B”) 430. The first client device 420 and the second client device 430 are parts of a coupled set. For example, the first client device 420 can be a left earbud and the second client device 430 can be a right earbud. Although there are three devices 410, 420, 430 in the illustration for the purpose of brevity, the interactions disclosed herein can be expanded to any number of devices.

At block 440, both the first client device 420 and the second client device 430 can be connected to the arbiter device 410 as parts of a coupled set. As described in relation to FIG. 2, the arbiter device 410 can maintain “coupled set” information (e.g., coupled set information 234 of FIG. 2) for the first client device 420 and the second client device 430.

At block 442, the arbiter device 410 can receive a “switch arbiter” message. In some instances, the “switch arbiter” message may be a forwarded arbiter switch message (e.g., the “switch arbiter request” message 342 of FIG. 3) originally received by the first client device 420. Alternatively, the “switch arbiter” message may be a message from a different arbiter device (not shown). Regardless, if the source device of the message is a trusted device (e.g., in a list of trusted devices 238 of FIG. 2), the arbiter device 420 can send a message 444 that informs the first client device 420 to disconnect at block 446.

At block 448, the arbiter device 410 can determine whether any other client devices are in the coupled set that includes the first client device 420. In the example procedure 400, the second client device 430 is in the coupled set. Based on the determination that the second client device 430 is in the coupled set with the first client device 420 that is disconnected or to be disconnected, the arbiter device 410 can send or forward the “switch arbiter” message it received at block 442 to the other client devices in the coupled set. Following with the example procedure 400, the arbiter device 410 forwards the “switch arbiter request” message 450 to the second client device 430.

In response, the second client device 430 can send a “switch arbiter response” message 452 to the arbiter device 410. At block 454, the second client device 430 can disconnect from the arbiter device 410 and start searching for a different arbiter device.

While the above example illustrates forwarding of the “switch arbiter” message to only the second client device 430 of the coupled set, a coupled set may be configured to contain greater number of client devices. Accordingly, it is to be understood that a coupled set can contain three or more client devices and the example procedure 400 can be expanded to forward the “switch arbiter” message to all client devices in any given coupled set. In those instances, an arbiter device can drop (disconnect) each client device after the arbiter device receives an accept (e.g., a switch arbiter response 452) message. It is noted that, in some implementations, the order of the blocks in the procedure 400 can be rearranged, performed simultaneously or sequentially, and certain blocks may be omitted entirely.

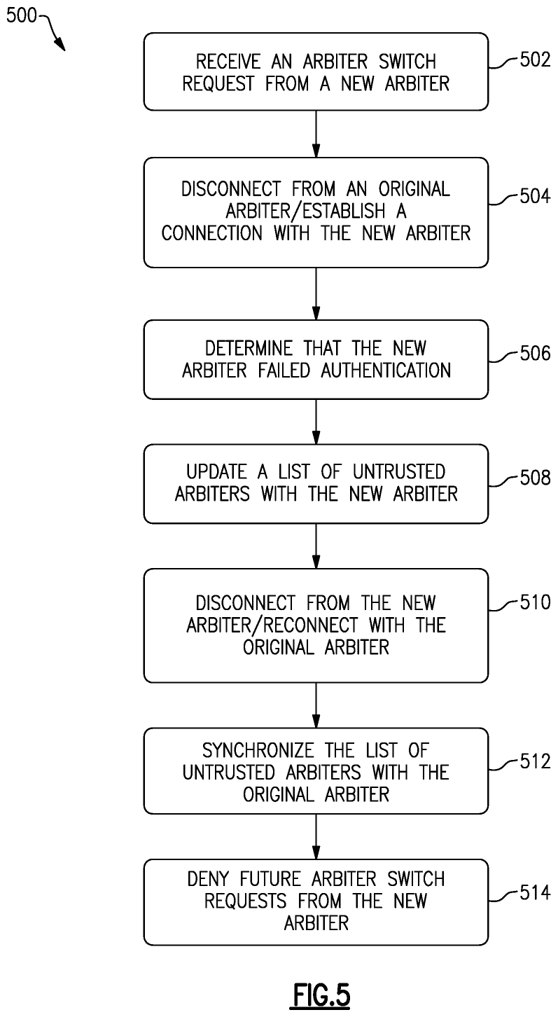

FIG. 5 depicts an example flowchart 500 of a method that can be used to prevent arbiter switch denial-of-service (DDoS) attacks, in accordance with one or more embodiments. The method can be implemented at a client device. For the flowchart, it is assumed that the client device is actively connected to an arbiter which can be referred as an “original arbiter.”

At block 502, the client device can receive an arbiter switch request (e.g., “switch arbiter request” message 342 of FIG. 3). The arbiter switch request can request the client device to, instead of the original arbiter, connect to a new arbiter. The new arbiter can be a malicious actor (device) that took on an identity of a trusted/trustable device. For example, the new arbiter could be using a trusted arbiter's MAC address when making the arbiter switch request.

At block 504, unaware of the new arbiter's malicious intent, the client device may disconnect from the original arbiter and establish a connection with the new arbiter. Since the client device is no longer connected to the original arbiter, if the client device has disconnected, a DDoS attack has been thus far successful.

At block 506, the client device can determine that the new arbiter has failed authentication. Various known authentication protocols may be utilized. For the authentication, the client device may use an authentication protocol previously agreed with legitimate arbiter devices. The original arbiter device should pass but the new arbiter device should fail the authentication protocol.

At block 508, the client device can update its list of untrusted arbiters regarding the new arbiter. The update can involve removal of the new arbiter from a list of trusted arbiters (e.g., the list of trusted devices 218 of FIG. 2), addition of the new arbiter to a list of untrusted arbiters (e.g., untrusted devices 220 of FIG. 2), or both.

At block 510, the client device can disconnect from the new arbiter and reconnect with the original arbiter. The client device may use previous connection information (e.g., the connections information 222 of FIG. 2) with the original arbiter in reconnecting with the original arbiter.

At block 512, using the reestablished connection, the client device can synchronize its updated list of untrusted arbiters with a list of trusted/untrusted devices at the original arbiter device (e.g., trusted devices 238 and untrusted devices 240 of FIG. 2). Accordingly, the original arbiter can become aware that the new arbiter is a malicious actor.

At block 514, the client device can deny future arbiter switch request(s) from the new arbiter based on its own updated list of trusted/untrusted devices. The arbiter switch request(s) from the new arbiter should no longer cause the client device from disconnecting from the original arbiter. Accordingly, this method can be used to prevent a malicious arbiter from continuously taking over the client device.

In addition to the synchronization at block 512, it is noted that a client device can synchronize its list of trusted or untrusted arbiters with other devices at any time. Further, the client device can receive a device's (including client devices in the same coupled set) list of trusted or untrusted arbiters at any time. For example, a client may send or receive such lists at connection establishment, during connection, at connection termination, or the like. Accordingly, a client device and an actively connected arbiter device can have their lists of trusted/untrusted devices in sync at all time. In some instances, the synched list may enable a synched client device to trust messages from a synched arbiter device without a need to determine whether to accept or reject the messages.

In some embodiments, an arbiter device may receive a message (e.g., arbiter switch message) directly from another arbiter device. The arbiter device can use its updated (synched) trusted/untrusted devices list to accept or reject the message.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A system comprising:
an arbiter device;
a first client device and a second client device configured as parts of a coupled set; and
a wireless network architecture that communicatively couples the arbiter device, the first device, and the second device, the arbiter device configured to:
receive a switch arbiter message from the first client device,
determine that the coupled set includes the first client device and the second client device, and
based on the determination, forward the switch arbiter message to the second client device.

2. The system of claim 1 wherein the arbiter device is configured to receive an acknowledgement from the second client device, and in response to the acknowledgment, disconnect the second device.

3. The system of claim 2 wherein the first client device is configured to receive an acknowledgment from the arbiter device, and in response to the acknowledgment, disconnect a connection to the arbiter device.

4. The system of claim 1 wherein the first client device is configured to receive the switch arbiter message from a second arbiter device, and forward the switch arbiter message to the arbiter device.

5. The system of claim 4 wherein the first client device is configured to make a determination that the second arbiter device is a trusted arbiter device, and based on the determination, forward the switch arbiter message to the arbiter device.

6. The system of claim 4 wherein the first client device is configured to receive an acknowledgement of the switch arbiter message from the arbiter device, and based on the acknowledgment, disconnect from the arbiter device.

7. The system of claim 6 wherein the first client device is configured to determine that the second arbiter device is an unauthorized device, disconnect a connection to the second arbiter device, and deny future switch arbiter messages from the second arbiter device.

8. The system of claim 7 wherein the first client device is configured to reconnect with the arbiter device, and inform the arbiter device that the second arbiter device is the unauthorized device.

9. The system of claim 1 wherein the first client device is configured to receive a second switch arbiter message from a third arbiter device, make a determination that the third arbiter device is an untrusted arbiter device, and based on the determination, reject the second switch arbiter message.

10. The system of claim 9 wherein the first client device is configured to inform the arbiter device whether the third arbiter device is a trusted arbiter device during a connection establishment with the arbiter device.

11. The system of claim 1 wherein the arbiter device maintains a first list of trusted arbiter devices and the first client device maintains a second list of trusted arbiter devices.

12. The system of claim 11 wherein the first list of trusted arbiter devices and the second list of trusted arbiter devices are maintained in sync.

13. The system of claim 12 wherein the arbiter device is configured to send the first list of trusted arbiter devices to the second client device based on a determination that the coupled set includes the first client device and the second client device.

14. The system of claim 11 wherein the first client device is configured to remove a second arbiter device from the second list of trusted arbiter devices based on a failed authentication of the second arbiter device to the first client device.

15. The system of claim 1 wherein the arbiter device is configured to send a coupled set change message to the second client device based on a determination that the coupled set includes the first client device and the second client device.

16. The system of claim 15 wherein the coupled set change message reflects a removal of the second client device from the coupled set.

17. The system of claim 1 wherein the second client device is configured to receive the switch arbiter message from the arbiter device, disconnect a connection to the arbiter device, and search for a connection request from a second arbiter device.

18. The system of claim 1 further comprising a third client device configured as a part of the coupled set wherein the first client device and the third client device are associated with the same position within the coupled set.

19. The system of claim 18 wherein the first arbiter device disconnects a first connection to the first client device and establishes a second connection with the third client device based on the first client device and the third client device having the same position within the coupled set.

20. A wireless electronic device configured to receive a disconnection request from a first device, disconnect the first device, determine that the first device is in a set with a second device, and forward the disconnection request to the second device based on the determination.
